(19) United States
(12) Patent Application Publication
(10) Pub. No.: US 2022/0242027 A1
(43) Pub. Date: Aug. 4, 2022

(54) MELT FILTER

(71) Applicant: Katharina Schulz, Linz (AT)

(72) Inventor: Katharina Schulz, Linz (AT)

(21) Appl. No.: 17/611,798

(22) PCT Filed: Apr. 30, 2020
(86) PCT No.: PCT/AT2020/060175

§ 371 Date: Nov. 16, 2021

(30) Foreign Application Priority Data
May 21, 2019 (AT) A50464/2019

(51) Int. Cl. B29C 48/27; B29C 48/691

(52) U.S. Cl. CPC B29C 48/273; B29C 48/6914

(57) ABSTRACT

The invention relates to a melt filter (1) for filtering plastic melts, comprising a screen rotor (3) which is arranged such that it can be rotationally driven between two housing plates (2) and which has recesses (5) along a circular path (4) for receiving exchangeable filter elements (6), and comprising a melt channel (7) which penetrates the housing plates (2) in the region of the circular path (4) and is associated with the screen rotor (3). In order to create advantageous conditions, it is proposed that the screen rotor (3) comprises two axially spaced rotor cheeks (9) which are provided opposite one another with filter elements (6) through which the plastic melt can flow and towards which the melt channels (7) of the two housing plates (2) open out, wherein at least one collecting chamber (10) for plastic melt filtered by the filter elements (6) is provided in the screen rotor (3) between opposing filter elements (6), and wherein a flow channel (11) opening out of the screen rotor (2) in the region of the rotor axis (8) is provided for discharging filtered plastic melt from the collecting chamber (10).

### FIELD OF THE INVENTION

The invention relates to a melt filter for filtering plastic melts, comprising a screen rotor which is arranged rotatably about a screen rotor axis between two housing plates and which has recesses along a circular path for receiving exchangeable filter elements, and comprising a melt channel penetrating the housing plates in the region of the circular path for plastic melt to be filtered, wherein the screen rotor forms a transport means for the filter elements, by means of which the filter elements can be displaced about the screen rotor axis at least between one filter position and a further position.

### DESCRIPTION OF THE PRIOR ART

With such devices, plastics, in particular plastics to be reprocessed, are to be economically viable freed from foreign substances or separated from other plastics which are not dissolved in the melt, prior to their further processing. In this mixture to be processed there are contaminants to be filtered out, such as adhesive strips, labels, aluminum closure lids and the like, as well as plastics to be filtered out, for example polypropylene, PET or the like, which have a higher melting point, wherein it is difficult to separate these substances by utilizing different specific densities, in particular smaller dirt particles. A complicating factor is that the quantity of substances to be filtered out can be very high, which considerably increases the cleaning effort and naturally places a considerable load on the filters provided. For this reason, the plastic is first melted after rough cleaning and then conveyed through the device.

For the filtration of contaminated masses it is known to provide a device mentioned at the beginning (DE4240461C1). In this known device, the filters are interchangeably held in a disc which interchangeably receives the filter elements in recesses arranged on a circular path. The individual filters are thus arranged in a kind of drum magazine, which makes it possible to constantly introduce new filters into the flow channel through which the melt flows by rotating the disc by the angular offset between two filter inserts. A continuous cleaning of the filter inserts is not provided. By means of a drive, the disc can be moved from a working position in which the screening process takes place to an alternating position in which the respective filter element can be changed. Due to the high axial forces acting on the screen rotor caused by the melt to be cleaned, the device is subject to considerable wear.

Furthermore, a device for the continuous filtering of impurities from a plastic melt is known from EP 2 061 575 A1, wherein a filter insert is provided in the form of a hollow rotating body which is mounted rotatably about its axis of rotation relative to a housing and through which the plastic melt flows and which is arranged in a flow channel of the housing between a feed channel for the plastic melt to be filtered and a discharge channel for the filtered plastic melt. In addition, a screw conveyor cooperating with the filter element is provided as a discharge device for impurities retained by the filter. In order to enable a quick and easy filter change with a simple construction, the filter insert comprises a disc-shaped filter arranged on the front side of the rotation body and coaxial to the axis of rotation. In addition, the discharge device includes at least one scraper arranged behind the screw conveyor in the direction of rotation of the filter insert and set against the filter. A disadvantage of this device is that the device has to be taken out of operation for a filter change, which means that downtimes of the device have to be accepted.

### SUMMARY OF THE INVENTION

The invention is based on the object of creating a device of the type described above which avoids the above-mentioned disadvantages and which, with the simplest possible construction, permits a rapid and problem-free filter change without having to be taken out of operation and which is subject to reduced wear.

The invention solves the problem set in that the screen rotor comprises two axially spaced rotor cheeks which are equipped opposite one another with filter elements through which the molten plastic can flow and towards which the melt channels of the two housing plates open out, wherein at least one collecting chamber for filtered plastic melt through which the screen discs flow is provided in the screen rotor between opposing filter elements, and wherein a flow channel opening out of the screen rotor in the region of the rotor axis is provided for discharging filtered plastic melt from the collecting chamber.

The screen rotor is either rotatably mounted with a shaft or with axle stubs in the two housing plates or is rotatably mounted on a rotor axis held in a rotationally fixed manner in the two housing plates. In addition, the screen rotor has on both sides, in the rotor cheeks facing away from each other, a plurality of screen nests equipped with filter elements. The two opposing filter elements of a pair of filter elements, through which the plastic melt can flow, are simultaneously acted upon by the likewise opposing melt channels of the two housing plates with plastic melt to be filtered, as a result of which the forces acting on the screen rotor in the axial direction practically cancel each other out, with the result that considerably lower forces have to be applied to rotate the screen rotor and the device is thus subject to less wear. Between the opposing filter elements of at least one pair of filter elements, at least one collecting chamber is provided in the screen rotor for filtered plastic melt through which the screen discs flow. This collecting chamber opens out of the screen rotor via the flow channel in the area of the rotor axis.

In order to be able to discharge the filtered plastic melt advantageously from the device, a housing plate in the bearing area of the rotor axis can have an annular channel groove next to a rotor cheek, into which the flow channel opens and to which annular channel groove a discharge channel in the housing plate for filtered plastic melt connects. Preferably, only a segment of the annular channel groove extends around the rotor axis, i.e. not fully circumferentially. In this way, the flow channel can be closed and an overflow of plastic melt can be prevented when a pair of filter elements with the screen rotor is displaced to a filter element change position. Alternatively, a rotor shaft can be provided which is fixed with respect to the housing plates and on which the screen rotor is mounted so as to be rotatable about the screen rotor axis, wherein the rotor shaft forms the flow channel which is adjoined by a discharge channel for filtered plastic melt guided through a housing plate. If the flow channel is formed by grooves in the rotor axis surface, the device can be cleaned particularly easily in the disassembled state.

In the present case, the filtering position is a filtering area in which plastic melt to be filtered flows simultaneously through two or more pairs of filter elements opposite and facing each other. In a further position about the screen rotor axis, a backwash position or backwash area is provided outside the filter area in which the filter elements can be backwashed with already filtered plastic melt for cleaning the filter elements. This backwashing can be carried out via a separate conduit from outside the device. However, it is particularly advantageous to divert part of the filtered melt flow and thus carry out the backwashing.

For this purpose, it is advisable if the fixed rotor shaft has, between the two housing plates, at least one backwashing line which passes radially through the rotor shaft and which, at one end, connects to the flow channel and, at the other end, opens out at a backwashing position for the backwashing of filter elements, wherein a slide valve is arranged in the backwashing line, by means of which valve the backwashing line is optionally released or blocked.

If two collecting chambers for plastic melts filtered by the filter elements are provided in the screen rotor between two opposing filter elements, which collecting chambers are separated by a web, each filter element can be backwashed separately if necessary. The advantage is a higher backwash flow with a lower pressure drop at the filter element, which improves the cleaning performance. For this purpose, two backwashing lines would have to be provided and the slide valve would have to be displaceable between a backwash position for one filter element and a backwash position for the other, opposite filter element as well as a blocking position.

In particular, the screen rotor comprises at least three, preferably four or more, pairs of filter elements opposite each other, one, two or more of which are associated with a filtering position, one with a backwashing position and one or more with an alternating or waiting position. Thus, kidney-shaped distribution spaces extending along the circular path can be provided in the housing plates around the melt channels, by means of which, for example, one, two or more pairs of filter elements can simultaneously perform the filtration of the plastic melt. For this purpose, in particular the annular channel groove connects the flow channels of two or more pairs of filter elements.

A valve element can be provided in the annular channel groove between the flow channels of two or more pairs of filter elements, with which in particular the flow of the plastic melt to a pair of filter elements located in the backwash position can be set and/or controlled. The pressure required for backwashing is generated by the counterpressure of the tool following the melt filter, which presses a part of the melt in the opposite direction into the screen nest of the pair of filter elements in the backwash position and backwashes the filter elements. The backwashed, contaminated material is discharged through corresponding openings in the two housing plates.

The actuating location and position of the valve element, in particular a throttle, is determined by the viscosity as well as the contamination of the melt.

In order to be able to change the filter elements in the maintenance position easily and quickly, even during operation, it is advantageous if the housing plates have maintenance openings in the area of the change position of the filter element pairs, in particular openings which can be closed with covers and which penetrate the housing plates.

For the purpose of rotational adjustment of the screen rotor, the screen rotor can be equipped with a toothing on the outside circumference, in which an adjusting drive engages as a rotary drive for the screen rotor. The drive is effected via a feed unit which engages on a toothed rim of the screen rotor. This allows the rotary drive to be cycled as a function of the contamination of the melt. Instead of said feed unit, the rotor can also be rotationally driven via a rotary drive in the area of the screen rotor shaft, for example with a stepper motor. The rotary drive can be electric or hydraulic, discrete or continuous.

The screen nests move with the rotor through the working chamber via a preset number of cycles (speed) and filter the melt. The movement continues via a closed screen change position and a backwash position in which the screens are cleaned. As the contamination increases, so does the melt pressure, which is detected by a sensor in a feed channel. As the melt pressure increases, the number of cycles can be increased in order to backwash the screens at shorter intervals.

A discontinuous circulation movement, wherein the dwell time in the backwash is extended, is just as possible as a continuous circulation movement.

The screen rotor is preferably rotatably mounted in the two housing plates, wherein the two housing plates can be connected to one another via tie rods arranged circumferentially radially outside the rotor, in particular along a circular path, and pressing the housing plates against spacer elements arranged therebetween. The two housing plates are thus screwed together, for example, via tie rods with spacer tubes. By means of the spacer elements, a defined gap between the rotor and the housing plates can be set.

A connecting channel between the housing plates allows the flow against the rotor from both sides, which is why the melt channels of the two housing plates are preferably connected to each other via a connecting channel.

### BRIEF DESCRIPTION OF THE INVENTION

In the drawing, the subject matter of the invention is shown by way of example, wherein:

FIG. 1 shows a side view of a melt filter with a pair of filter elements in filter position,

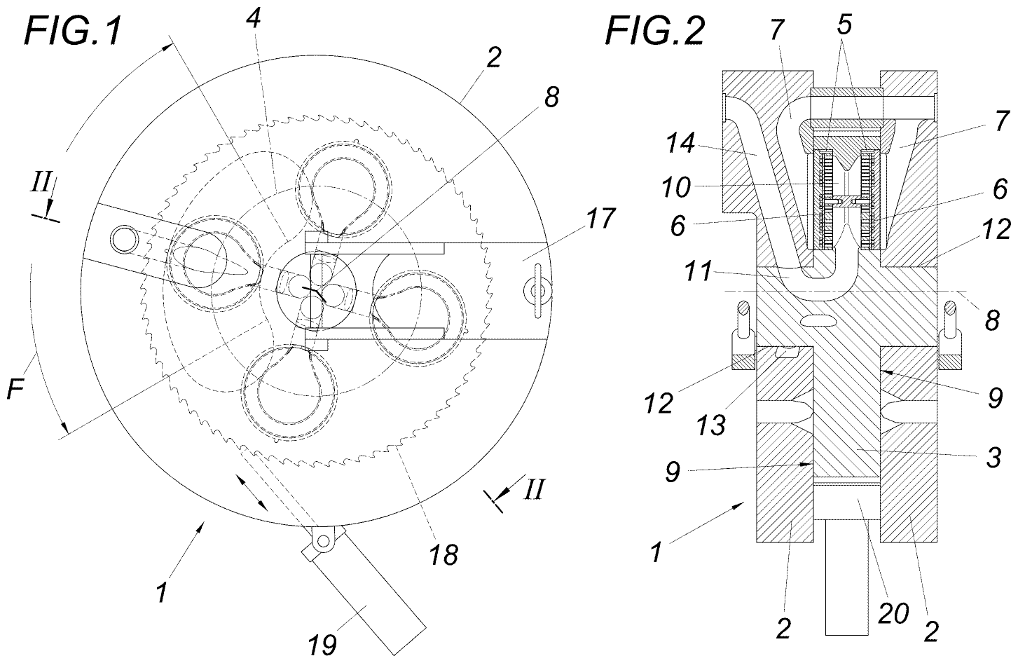

FIG. 2 shows the melt filter from FIG. 1 in section according to line II-II,

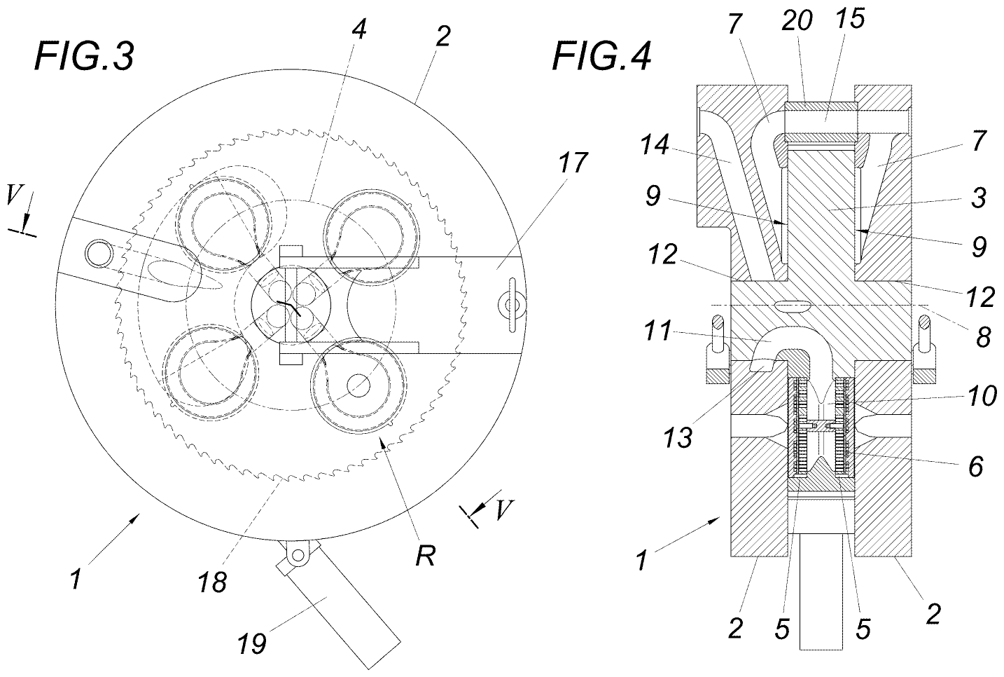

FIG. 3 shows a side view of the melt filter with two pairs of filter elements in filter position and one pair of filter elements in backwash position,

FIG. 4 shows the melt filter from FIG. 3 in section according to line IV-IV,

FIG. 5 shows the melt filter in side view with a pair of filter elements in filter position and a pair of filter elements in filter change position,

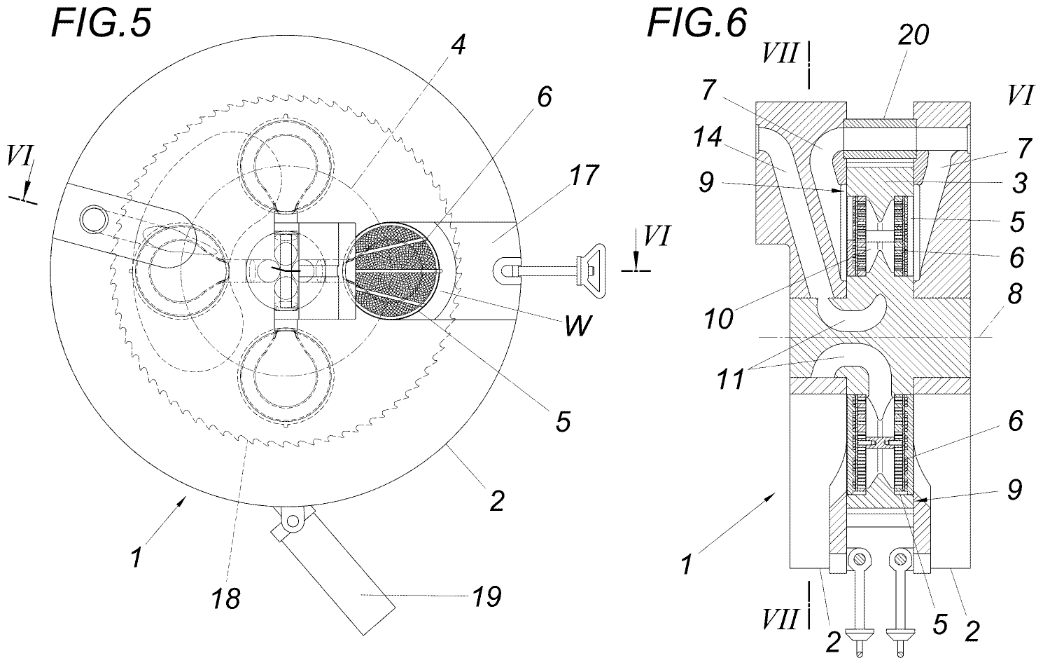

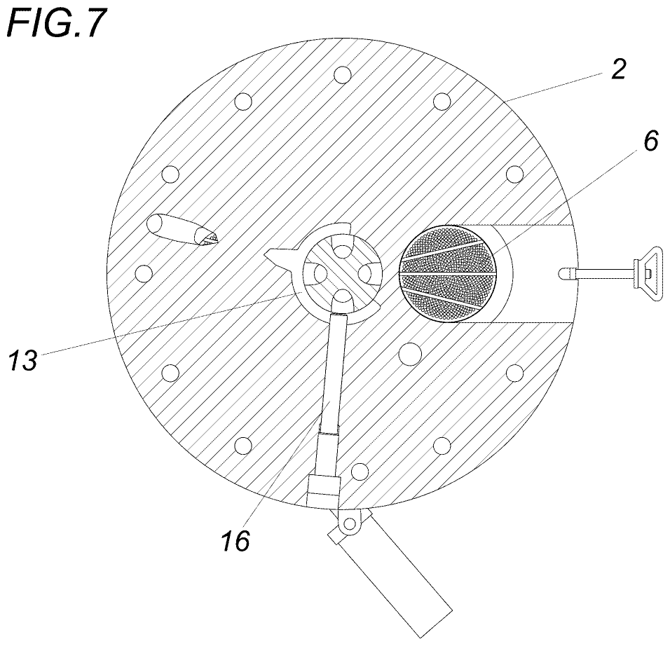

FIG. 6 shows the melt filter from FIG. 5 in section according to line VI-VI,

FIG. 7 shows the melt filter from FIG. 6 in section according to line VII-VII,

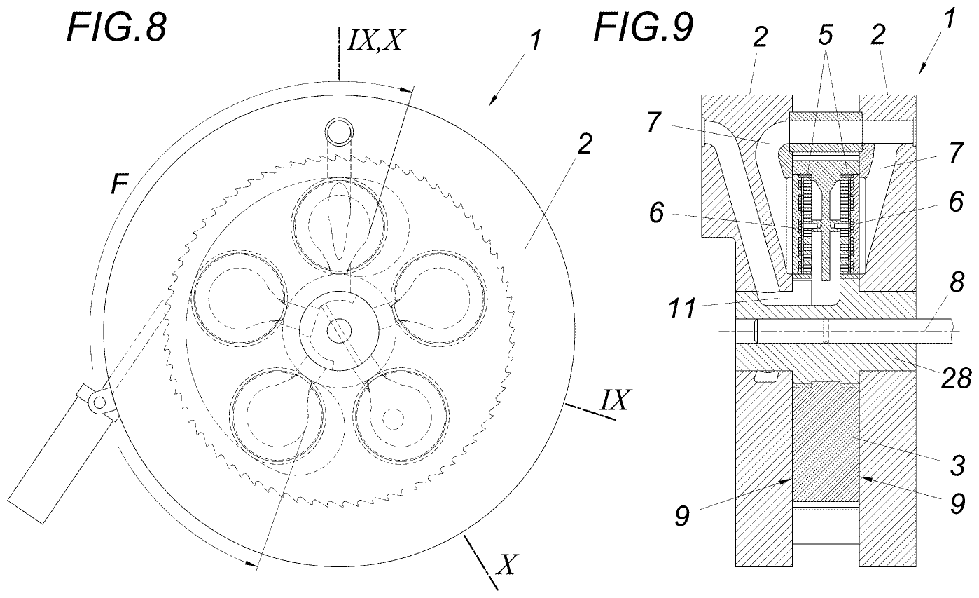

FIG. 8 shows a design variant of a melt filter in side view with three filter element pairs in filter position and one filter element pair in backwash position,

FIG. 9 shows the melt filter from FIG. 8 in section according to lines IX-IX and

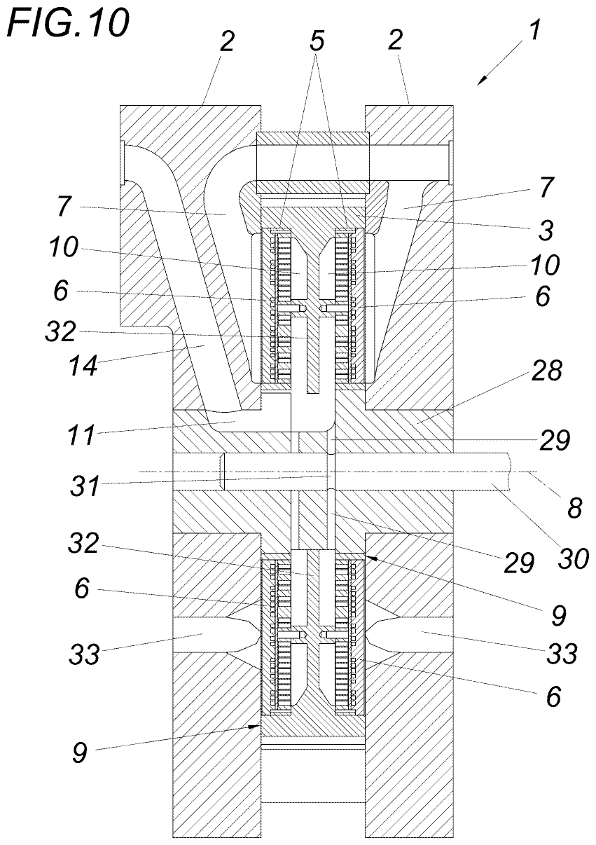

FIG. 10 shows the melt filter from FIG. 8 in section according to the line X-X.

### BRIEF DESCRIPTION OF THE PREFERRED EMBODIMENTS

The invention relates to a melt filter 1 for the purification of plastic melts, in particular those discharged by extruders, having a screen rotor 3 which is arranged in a rotatably drivable manner between two housing plates 2 and comprises recesses 5 along a circular path 4 for accommodating exchangeable filter elements 6, and having a melt channel 7 which penetrates the housing plates 2 in the region of the circular path 4 and is assigned to the screen rotor 3 in the region of the filter position of the filter elements 6, the screen rotor 3 in the region of the filter position of the filter elements 6, wherein the screen rotor 3 forms a transport means for the filter elements 6, with which the filter elements 6 can be displaced about the screen rotor axis 8 at least between a filter position F, a backwashing position R and an exchange or waiting position W. In the present exemplary embodiment, the melt channels 7 of the two housing plates 2 are connected to each other via a melt channel 15 formed by a sleeve 20 inserted between the two housing plates 2. However, both melt channels could also be supplied with melt to be filtered from the outside via a separate connection.

The screen rotor 3 comprises two axially spaced rotor cheeks 9, which are equipped opposite one another with filter elements 6 through which the plastic melt can flow and towards which the melt channels 7 of the two housing plates open out in the filter position. Between opposing filter elements 6, i.e. a pair of filter elements, a collecting chamber 10 for filtered plastic melt through which the filter elements 6 flow is provided in the rotational body of the screen rotor 3. The discharge of filtered plastic melt from the collecting chamber 10 takes place via a flow channel 11 in the region of the rotor axis 8.

According to the exemplary embodiment as shown in FIGS. 1 to 7, the screen rotor 3 is rotationally driven by two stub axles 12 between the two housing plates 2 and has on both sides, in the rotor cheeks 9 facing away from each other, several screen nests equipped with filter elements 6. The two directly opposite filter elements 6 of a pair of filter elements, through which the plastic melt can flow, are simultaneously acted upon by the likewise opposite melt channels 7 of the two housing plates 2 with plastic melt to be filtered, whereby the forces acting on the screen rotor 3 in the axial direction practically cancel each other out. Between the opposing filter elements 6 of at least one pair of filter elements, the collecting chamber 10 for filtered plastic melt pressed through the filter elements 6 is provided in the screen rotor 3. This collecting chamber 10 opens out of the screen rotor 3 via the flow channel 11 in the area of the rotor axis 8.

A housing plate 2 has, in the bearing region of the rotor axis 8, in addition to a rotor cheek 9, an annular channel groove 13, into which the flow channel 11 opens out and to which annular channel groove 13 a discharge channel 14 for filtered molten plastic adjoins. The screen rotor 3 comprises four opposing pairs of filter elements, one or two of which are assigned to a filter position, one to a backwash position and one to an alternating or waiting position. In addition, a valve element 16, in particular a throttle, is provided in the annular channel groove 13 between the flow channels 11 of two pairs of filter elements and is radially adjustably arranged in a radial bore of the of the housing plate 2. In the region of the exchange position W of the filter element pairs, the housing plates 2 have maintenance openings which can be closed, in particular with covers 17, and which penetrate the housing plates 2 axially, via which the filter elements can be exchanged. In addition, the screen rotor 3 is provided on its outer circumference with a toothing 18 in which an adjusting drive 19 engages as a rotary drive for the screen rotor 3. The screen rotor 3 is rotatably mounted in the two housing plates 2. In addition, the two housing plates 2 are connected to one another via tie rods arranged circumferentially radially outside the screen rotor 3, in particular along a further circular path, and pressing the housing plates 2 against spacer elements arranged therebetween. The melt channels 7 of the two housing plates 2 are connected to one another via a connecting channel 21.

In the exemplary embodiment according to FIGS. 1 to 7, the screen rotor 3 is rotatably mounted with axle stubs in the two housing plates 2. In the exemplary embodiment according to FIGS. 8 to 10, the screen rotor 3 is rotatably mounted on a rotor axis 28 held in a rotationally fixed manner in the two housing plates 2.

In this case, a rotor shaft 28, which is fixed with respect to the housing plates 2 and on which the screen rotor 3 is mounted so as to be rotatable about the screen rotor axis 8, forms the flow channel 11, which is adjoined by a discharge channel 14, guided through a housing plate 2, for filtered molten plastic.

The fixed rotor shaft 28 has, between the two housing plates 2, at least one backwashing line 29 which passes radially through the rotor shaft 28 and, at one end, adjoins the flow channel 11 and, at the other end, opens out at a backwashing position for the backwashing of filter elements, wherein a slide valve 30 is arranged in the backwashing line 29, by means of which valve the backwashing line 29 is optionally released or blocked. The slide valve 30 is mounted coaxially to the screen rotor axis 8 in the rotor shaft 28 in such a way that it is displaceable along the screen rotor axis 8. The slide valve 30 also has a bore radially extending through the slide valve 30, which bore can be brought into overlap with the respective backwashing line in order to release the flow through this backwashing line. The bore radially extending through the slide valve 30 may also be replaced by an annular groove on the periphery of the slide valve. Two collecting chambers 10, separated by a web 32, for plastic melts filtered by the filter elements 6 are provided in the screen rotor 3 between each two opposing filter elements 6, so that each filter element 6 can be backwashed separately in the corresponding slide valve position (FIG. 10 below). For this purpose, in the backwash position, the web 32 lies sealingly against the rotor shaft 28. Material cleaned by the respective filter element 6 is discharged from the device via a channel 33.

1. A melt filter for filtering a plastic melt, said melt filter comprising:
a screen rotor arranged between two housing plates such that said screen rotor rotates about a screen rotor axis;
wherein said screen rotor has recesses along a circular path accommodating exchangeable filter elements and said screen rotor has a melt channel penetrating the housing plates in a region of the circular path receiving the plastic melt that is filtered;
wherein the screen rotor forms a transport structure for the filter elements by which the filter elements are displaced about the screen rotor axis at least between a first filter position and a further filter position;
wherein the screen rotor has two axially spaced rotor cheeks opposite one another with the filter elements through which the plastic melt flows and towards which the melt channels of the two housing plates open out;
wherein the screen rotor has at least one collecting chamber receiving the plastic melt filtered by the filter elements in the screen rotor between opposing filter elements; and
wherein the screen rotor has a flow channel opening out of the screen rotor in the region of the rotor axis discharging the filtered plastic melt from the collecting chamber.

2. The melt filter according to claim 1, wherein one of the housing plates in a bearing region of a screen rotor shaft has, next to one of the rotor cheeks, an annular channel groove into which the flow channel opens out and to which a discharge channel for the filtered plastic melt adjoins.

3. The melt filter according to claim 1, wherein a rotor shaft that is fixed with respect to the housing plates and on which the screen rotor is mounted rotatably about the screen rotor axis forms the flow channel which is adjoined by a discharge channel guiding the filtered plastic melt through one of the housing plates.

4. The melt filter according to claim 3, wherein the fixed rotor shaft has, between the two housing plates, at least one backwashing line that passes radially through the rotor shaft and that, at one end, adjoins the flow channel and, at the other end, opens out at a backwashing position backwashing the filter elements, wherein a slide valve is arranged in the backwashing line, said slide valve selectively releasing or blocking the backwashing line.

5. The melt filter according to claim 1, wherein the screen rotor has two collecting chambers, separated by a web receiving the plastic melt filtered by the filter elements between each two of the filter elements opposing each other.

6. The melt filter according to claim 1, wherein the screen rotor comprises at least three opposing pairs of the filter elements, one, two or more of which are associated with a filter position, one, two or more of which are associated with a backwash position, and one, two or more of which are associated with an alternate or waiting position.

7. The melt filter according to claim 2, wherein the annular channel groove connects the flow channels of two pairs of the filter elements.

8. The melt filter according to claim 2, wherein a valve element is provided in the annular channel groove between the flow channels of two pairs of the filter elements.

9. The melt filter according to claim 6, wherein the housing plates have, in a region of an exchange position of the filter element pairs, maintenance openings that can be closed and that penetrate the housing plates.

10. The melt filter according to claim 1, wherein the screen rotor is rotatably mounted between the two housing plates, and the two housing plates are connected to one another with tie rods arranged circumferentially radially outside the rotor and pressing the housing plates against spacer elements arranged therebetween.

11. The melt filter according to claim 1, wherein the screen rotor comprises four or more opposing pairs of the filter elements, one, two or more of which are associated with a filter position, one, two or more of which are associated with a backwash position, and one, two or more of which are associated with an alternate or waiting position.

12. The melt filter according to claim 11, wherein the housing plates have, in the region of an exchange position of the filter element pairs, maintenance openings that can be closed, in particular with covers, and that penetrate the housing plates.

13. The melt filter according to claim 12, wherein the maintenance openings are closed with covers.

14. The melt filter according to claim 9, wherein the maintenance openings are closed with covers.
